(19) United States
(12) Patent Application Publication
(10) Pub. No.: US 2012/0311677 A1
(43) Pub. Date: Dec. 6, 2012

(54) METHOD, SYSTEM AND DEVICE FOR RESTRICTING FROM LOGGING INTO A CHAT ROOM

(75) Inventor: Xi Chen, Shenzhen (CN)

(73) Assignee: TENCENT TECHNOLOGY (SHENZHEN) COMPANY LIMITED, Shenzhen City, Guangdong (CN)

(21) Appl. No.: 13/521,130

(22) PCT Filed: Jan. 12, 2011
(86) PCT No.: PCT/CN11/70202

§ 371 Date: Jul. 9, 2012

(30) Foreign Application Priority Data
Jan. 22, 2010 (CN) 201010102718.3

(51) Int. Cl. G06F 21/00

(52) U.S. Cl. 726/4

(57) ABSTRACT

A method, a system, and a device for restricting from logging into a chat room, which belongs to the computer field including, receiving a request from a client corresponding to a chat room administrator for forcing a specified user to exit the current chat room, and sending the client corresponding to the specified user a command to force the specified user to exit the current chat room and changing the status information of the specified user into the restricted state to restrict the specified user into the specified chat room according to the request. The system includes a server and a user client. The user forced to exit the current chat room is prevented from re-entering the chat room and affecting other users therein, but can still enjoy the chat room services in the chat room so as to avoid the chat room losing users and improve the user experience.

### BACKGROUND OF THE INVENTION

1. Technical Field

The present invention relates to the field of computers, in particular, to a method, a system and a device for restricting from logging into a chat room.

2. Description of Related Art

With the development of networking, more and more people communicate in network chat rooms to get close to each other. In practical use, if the operations of a certain user in a chat room affect the communication of others, like sending a great number of junk messages, advertisements or other offensive sensitive messages, the chat room shall have restrictions on the user.

At present, the method adopted by most of the chat rooms to restrict the users is to force the user to exit the current chat room and keep the user from reentering the current chat room for a certain period of time.

The inventor finds that the prior art at least has the following defects and disadvantages in the process of realizing the present invention:

The current restriction method can only keep the user from reentering the exited chat room for a certain period of time. The user still can enter other chat rooms to send adverse or sensitive messages. However, if the user is restricted from entering all chat rooms, the user may fail to use the chat room services and thus exit the chat room client, which will cause loss of user for the chat room services.

### BRIEF SUMMARY OF THE INVENTION

To avoid a user who was forced to exit the current chat room from re-entering the chat room and affecting other users therein, and to ensure that the user can still enjoy the chat room services in a specified chat room, the present invention provides a method, a system and a device for restricting from logging into a chat room. The technical solution is as follows:

One objective of this invention is to provide a method for restricting from logging into a chat room. Said method comprises:

receiving a request from a client corresponding to a chat room administrator for forcing a specified user's identity to exit the current chat room;

and sending the client corresponding to the specified user a command to force the specified user's identity to exit the current chat room and changing the status information of the specified user into the restricted state so as to restrict the specified user's identity in a specified chat room according to the request.

One objective of this invention is to provide a system for restricting from logging into a chat room. Said system comprises a server and a user client, wherein

the server comprises a first receiving module and a first processing module;

the first receiving module is used for receiving a request from a client corresponding to a chat room administrator for forcing a specified user's identity to exit the current chat room;

the first processing module is used for sending the client corresponding to the specified user a command to force the specified user's identity to exit the current chat room, and changing the status information of the specified user into the restricted state, so as to restrict the specified user's identity in a specified chat room according to the request received by the first receiving module;

and the user client is used for receiving the above-mentioned command from the server to force the specified user's identity to exit the current chat room.

One objective of this invention is to provide a server for restricting from logging into a chat room. Said server comprises:

a first receiving module for receiving a request from a client corresponding to a chat room administrator for forcing a specified user's identity to exit the current chat room;

a first processing module for sending the client corresponding to the specified user a command to force the specified user's identity to exit the current chat room, and changing the status information of the specified user into the restricted state to restrict the specified user's identity in a specified chat room according to the request received by the first receiving module.

One objective of this invention is to provide a user client for restricting from logging into a chat room. Said user client comprises a receiving module and a processing module or a sending module and a login module, wherein

the receiving module is used for receiving a command from a server to force a specified user's identity to exit the current chat room;

the processing module is used for processing the command received by the receiving module so as to force the specified user's identity to exit the current chat room;

the sending module is used for sending the server a request for permitting the specified user's identity to log into the chat room;

the login module is used for permitting the specified user's identity to log into the chat room after the server receives the request.

The technical scheme provided by the embodiment of the present invention has the advantages that:

The request for forcing the specified user to exit the current chat room is sent to the server via the chat room administrator, the server according to the request, sends the client corresponding to the specified user the command to force the specified user to exit the current chat room and changes the status information of the specified user into the restricted state, which restricts the specified user in the specified chat room, so as to avoid the user being forced to exit the chat room from re-entering the chat room and influencing others in the chat room. Meanwhile it ensures that the user can still enjoy the chat room services in the specified chat room, so that the chat room services avoid losing users and the user experience gets better.

### BRIEF DESCRIPTION OF THE SEVERAL VIEWS OF THE DRAWINGS

FIG. 1 is a flowchart of a method for restricting from logging into a chat room in embodiment 1;

FIG. 2 is a flowchart of a method for restricting from logging into a chat room in embodiment 2;

FIG. 3 is a flowchart of a method for restricting from logging into a chat room in embodiment 3;

FIG. 4-a is a schematic view of one system for restricting from logging into a chat room in embodiment 4;

FIG. 4-b is a schematic view of another system for restricting from logging into a chat room in embodiment 4;

FIG. 5 is a schematic view of a server for restricting from logging into a chat room in embodiment 5;

FIG. 6 is a schematic view of a server for restricting from logging into a chat room in embodiment 5;

FIG. 7 is a schematic view of a server for restricting from logging into a chat room in embodiment 5;

FIG. 8 is a schematic view of a user client for restricting from logging into a chat room in embodiment 6.

### DETAILED DESCRIPTION OF THE INVENTION

To make the objective, technical solutions, and advantages of the present invention more clear, the embodiments of the present invention will be further described in detail by combining them with the attached drawings.

### Embodiment 1

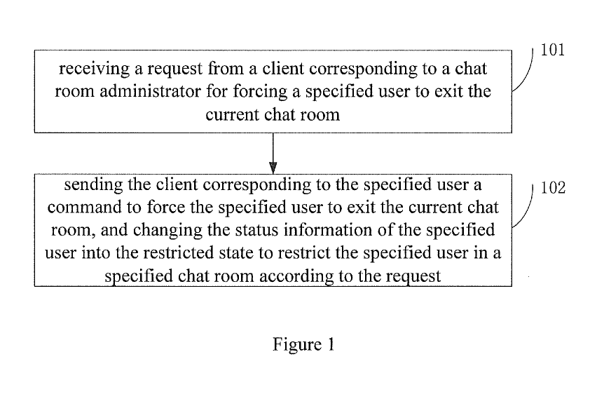

This embodiment provides a method for restricting from logging into a chat room. As shown in FIG. 1, the method comprises the following steps:

101: receiving a request from a client corresponding to a chat room administrator for forcing a specified user's identity to exit the current chat room;

102: sending the client corresponding to the specified user a command to force the specified user's identity to exit the current chat room, and changing the status information of the specified user into the restricted state to restrict the specified user's identity in a specified chat room according to the request.

wherein, there are usually two user states: “normal state” and “restricted state”, the users in the “normal state” are allowed to enter any chat room, and the users in the “restricted state” are only permitted to enter the specified chat rooms, and there are other states during implementation, which are not defined in this embodiment; when sending the client corresponding to the specified user the command to force the specified user to exit the current chat room, the server changes the status information of the specified user from the “normal state” into the “restricted state”, at this moment the specified user will be restricted in the specified chat room; the server or the client of the administrator acquires the ID (identity) of the specified chat room, the server can preset the ID of the chat room, e.g. designate two chat rooms of which the IDs are A and B respectively, in advance. When it is necessary to restrict the users, the server is capable of directly restricting the user in the chat room A or B; if the ID of the chat room is determined by the administrator's client, the administrator's client is capable of designating one or more chat rooms as the specified chat rooms, e.g.: in the case of many users are required to be restricted, there can be many specified chat rooms, and in the case of a few users are required to be restricted, there can be one specified room. It is not specifically defined in this embodiment during implementation.

Moreover, the method further comprises:

receiving a user request for logging into a chat room;

querying the status information of the user;

and when the user is in the restricted state, and if the chat room which the user requests to log into is a specified chat room, accepting the request and permitting the user to log into the specified chat room; if the chat room which the user requests to log into is not the specified chat room, rejecting the request and refusing the user to log into the chat room.

Furthermore, the method further comprises:

acquiring the restriction conditions of the specified user and changing the status information thereof according to the restriction conditions. The above restriction conditions may be restrictions on time or others, e.g.: restricting the specified user from sending adverse messages into a certain specified chat room in a predetermined time period, counting the predetermined time, and permitting the specified user to log into other normal chat rooms until the time is up,

The specified user is restricted in a chat room and then the judgment on whether to accept the login request of the specified user is made according to the status information, the judgment of the status information is also related to restriction conditions, wherein the restriction conditions are capable of being preset in a server or set by the chat room administrator and then sent to the server. In this embodiment, the restriction conditions are set by the chat room administrator and then sent to the server. The restriction conditions are illustrated with time.

wherein the abovementioned method for restricting the users from logging into the chat room can be applied to scenarios with room concepts, such as network chat rooms, network games or others, which is not specifically defined in this embodiment.

In conclusion, according to the method provided by this embodiment, the specified user sending adverse messages is forced to exit the current chat room and restricted in the specified chat room in a period of time to prevent the user being forced to exit the current chat room from re-entering the chat room and influencing other users therein, and to ensure that the user forced to exit can still enjoy the chat room services, so the chat room services avoid losing users and the user experience gets better.

The method provided by the above embodiment is described by the following embodiments.

### Embodiment 2

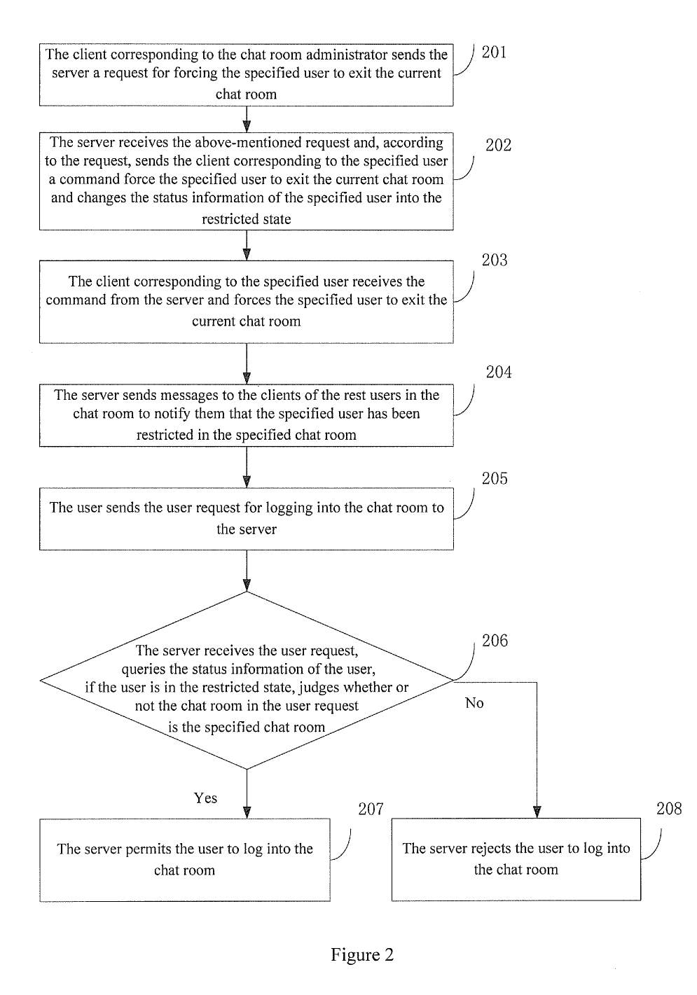

To prevent a user being forced to exit the current chat room from re-entering the chat room and affecting other users therein, and to ensure that the user can still enjoy the chat room services in a specified chat room, the present embodiment provides a method for restricting from logging into a chat room. As shown in FIG. 2, the method comprises the following steps wherein:

201: the client corresponding to a chat room administrator sends the server a request for forcing a specified user to exit the current chat room;

wherein the above specified user refers to the user sending junk messages, advertisements or other adverse sensitive messages to other users in the chat room. When the specified user is detected, the client of the chat room administrator will send the server the request for forcing the specified users to exit the current chat rooms, and the chat rooms may be network chat rooms, rooms of network games, etc., which is not specifically in this embodiment;

202: the server receives the abovementioned request from the client corresponding to the chat room administrator, and sends the client corresponding to the specified users a command to force the specified user to exit the current chat room and changes the status information of the specified user into the restricted state according to the request;

wherein, there are usually two user states: “normal state” and “restricted state”, the users in the “normal state” are allowed to enter any chat room, and the users in the “restricted state” are only permitted to enter the specified chat rooms, and there are other states during implementation, which are not defined in this embodiment; when sending the client corresponding to the specified user the command to force the specified user to exit the current chat room, the server changes the status information of the specified user from the “normal state” into the “restricted state”, at this moment the specified user will be restricted in the specified chat room; the server or the client of the administrator acquires the ID (identity) of the specified chat room, the server can preset the ID of the chat room, e.g. designate two chat rooms of which the IDs are A and B respectively, in advance. When it is necessary to restrict the users, the server is capable of directly restricting the user in the chat room A or B; if the ID of the chat room is determined by the administrator's client, the administrator's client is capable of designating one or more chat rooms as the specified chat rooms, e.g.: in the case of many users are required to be restricted, there can be many specified chat rooms, and in the case of a few users are required to be restricted, there can be one specified room. It is not specifically defined in this embodiment during implementation;

wherein one or more specified users can be restricted in the same specified chat rooms, or each specified user is respectively restricted into one specified chat room or in other combinations of ways, which means there can be one or more specified chat rooms, e.g.: there are two specified chat rooms of which the IDs are A and B respectively, and two specified users, the two specified users can be respectively placed in two specified chat rooms or in the specified chat room A or B, which is not specifically defined in this embodiment; table 1 below is used for illustration:

TABLE 1

| | | ID of Specified Chat | |
|---|---|---|---|
| User ID | Status information | Room | ID of Chat Room |
| 123456 | Restricted State | A, B | A |
| 234567 | Normal State | None | 1 |
| 345678 | Restricted State | A, B | B |

in the table, the user 123456 is in the restricted state due to sending adverse messages, and is restricted in the specified chat room A, while the user 234567 in the normal state is in the chat room 1; in the same way, the user 345678 is restricted in the specified chat room B;

besides, the ID of the specified chat rooms can be marked by letters, the normal chat rooms marked by numbers, or the former marked by numbers and the later marked by letters or in other ways, which is not specifically defined in this embodiment;

203: the client corresponding to the specified user receives the command from the server and then forces the specified user to exit the current chat room;

204: the server sends messages to the clients of the rest of the users in the chat room to notify them that the specified user has been restricted in the specified chat room;

wherein this step is optional, during actual use, when the specified user is restricted in the specified chat room, the server may not send a message to notify the rest of the users of the chat room, preferably, the server may also send the messages to notify the rest of the users of the chat room that the specified user has been restricted in the specified chat room, so as to improve the user experience of other users and give an alarm, which is not specifically defined in this embodiment;

subsequently, when receiving the user request for logging into the chat room, the server judges whether to permit the user to log into the corresponding chat room according to the user's status information, which is specifically defined in steps 205-208;

205: the user transmits the request for logging into the chat room to the server;

wherein the user may be a user in the normal state or a specified user in the restricted state; if the specified user wants to log into a chat room, the specified user will re-send the request for logging into the chat rooms to the server, wherein the chat rooms include normal chat rooms and other specified chat rooms;

206: the server receives the user request for logging into the chat room, queries the status information of the user, if the user is in the restricted state and the chat room which the user requests for logging into is the specified chat room, the server accepts the request and turns to step 207; otherwise, it rejects the request and turns to step 208;

e.g.: if the current user 123456 is the specified user, and is in the specified chat room A, if the user 123456 wants to log into the specified chat rooms other than the specified chat room A, such as chat room B, at this time the server will query the status information of the user 123456 and the chat room ID thereof, judge whether chat room B that the user requests to log into is the specified chat room, and if the user 123456 is in the restricted state and is in the chat room A and the specified chat room B is the specified chat room, permits the user 123456 to log into the specified chat room B;

e.g.: if the current user 123456 is a specified user and is in the specified chat room A, if the user 123456 wants to log into other normal chat rooms, other than the specified chat room A, such as chat room 1, at this time the server will query the status information of the user 123456 and the chat room ID thereof, judge whether the chat room that the user requests to log into is the normal chat room, and if the user 123456 is in the restricted state and is in chat room A and the chat room that the user requests to log into is a normal chat room, rejects the user 123456 to log into the chat room 1;

furthermore, when the chat room administrator sends a request for canceling restrictions on the specified user, the server changes the status information of the user from the “restricted state” into “normal state” according to the request, at this time, when the specified user sends the request for logging into a chat room, the login request of the specified user is permitted; or when the request for canceling restrictions on the specified user is not sent by the chat room administrator, the status information of the user keeps the “restricted state”.

when the user is in the normal state, the server permits the user to log into any chat room, including the normal chat room or other specified chat rooms;

207: the server permits the user to log into the specified chat room;

wherein after the server permits the user to log into the specified chat room, the client corresponding to the specified user executes the related login operations to make the specified user log into the specified chat room successfully, and then the flow ends.

208: the server rejects the user to log into the chat room;

wherein the specified user is continuously restricted in the specified chat room.

In conclusion, the specified user sending adverse messages is forced to exit the current chat room and restricted in a certain specified chat room and cannot log into the normal chat room until the chat room administrator sends the request for canceling the restriction, and when the specified user is still in the restricted state, the specified user is permitted to log into other specified chat rooms. According to the above-mentioned method, the user forced to exit from the current chat room is prevented from re-entering the chat room and affecting other users therein, but can still enjoy the chat room services in the chat room so as to avoid the chat room services losing users and improve the user experience.

### Embodiment 3

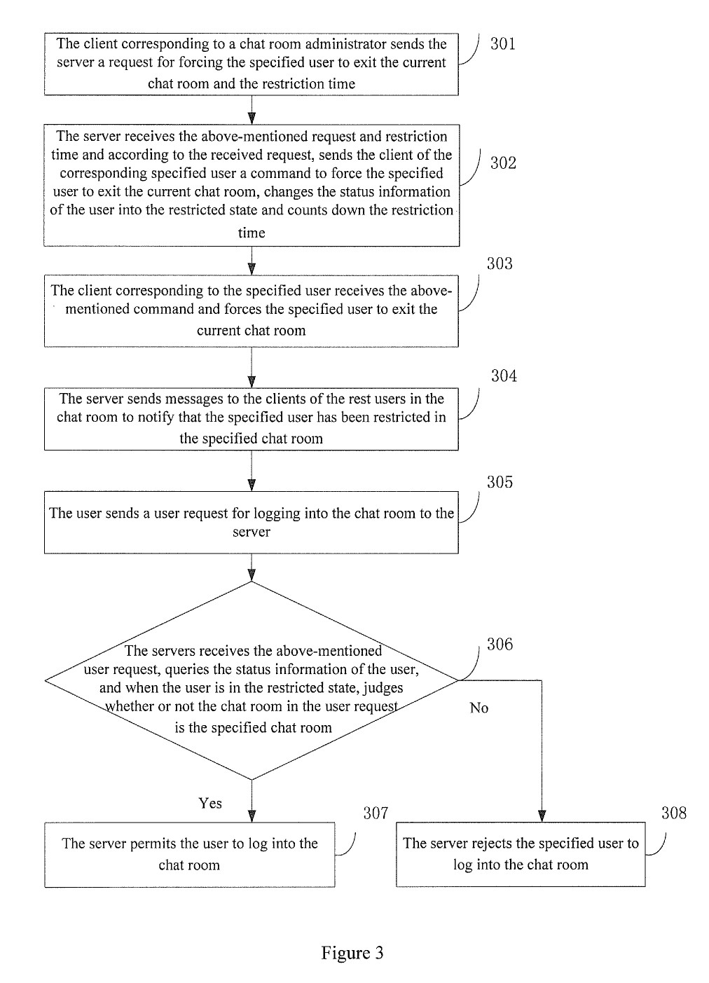

This embodiment provides a method for restricting users from logging into a chat room. According to the method, the specified user is restricted in a chat room and then the judgment on whether to accept the login request of the specified user is made according to the status information, the judgment of the status information is also related to restriction conditions, wherein the restriction conditions are capable of being preset in a server or set by the chat room administrator and then sent to the server. In this embodiment, the restriction conditions are set by the chat room administrator and then sent to the server. The restriction conditions are illustrated with time. As shown in FIG. 3, the method comprises the following steps:

301: the client corresponding to a chat room administrator sends the server a request for forcing a specified user to exit the current chat room and the restriction time;

wherein the restriction time is can be set by the chat room administrator according to the actual conditions, e.g. 1 min, 3 min, 5 min, etc., which is not specifically defined in this embodiment;

302: the server receives the above-mentioned request and the restriction time from the client of the chat room administrator, and sends the client corresponding to the specified users a command to exit the current chat room, changes the status information of the specified user into the restricted state, and counts down the restriction time according to the request;

wherein there are usually two user states: “normal state” and “restricted state”, the users in the “normal state” are allowed to enter any chat room, and the users in the “restricted state” are only permitted to enter the specified chat rooms, and there are other states during implementation, which are not specifically defined in this embodiment; when the server sends the client corresponding to the specified users the command to force the specified user to exit the current chat room, the status information of the specified user is changed from the “normal state” into the “restricted state”, then the specified user is restricted in the specified chat room; the server or the client of the administrator acquires the ID (identity) of the specified chat room, the server can preset the ID of the chat room, e.g.: designate two chat rooms of which the IDs respectively are A and B, in advance. When it is necessary to restrict the users, the server is capable of directly restricting the users in one of the two chat rooms A and B; if the ID of the chat room is determined by the administrator's client, the administrator's client is capable of designating one or more chat rooms as the specified chat rooms, e.g.: in the case of many users are required to be restricted, there can be many specified chat rooms, and in the case of a few users are required to be restricted, there can be one specified room. It is not specifically defined in this embodiment;

wherein one or more specified users can be restricted in the same specified chat rooms, or each specified user is respectively restricted into one specified chat room, or in any other combination of ways, which means there may be one or more chat rooms, e.g.: there are two specified chat rooms of which the IDs are A and B respectively and two specified users, the two specified users can be respectively placed in two specified chat rooms or in the specified chat room A or B, which is not specifically defined in this embodiment;

besides, the ID of the specified chat rooms can be marked by letters, the normal chat rooms marked by numbers, or the former marked by numbers and the later marked by letters or in other ways, which is not specifically defined in this embodiment;

303: the client corresponding to the specified user receives the command from the server and forces the specified user to exit the current chat room;

304: the server sends messages to the clients of the rest of the users in the chat room to notify them that the specified user has been restricted in the specified chat room;

wherein this step is optional, during actual use, when the specified user is restricted in the specified chat room, the server may not send a message to notify the rest of the users of the chat room, preferably, the server may also send the messages to notify the rest of the users of the chat room that the specified user has been restricted in the specified chat room to improve the user experience of other users and give an alarm, which is not specifically defined in this embodiment;

subsequently, when receiving the user request for logging into the chat room, the server judges whether to permit the user to log into the corresponding chat room according to the user's status information, which are specifically defined in steps 305-308;

305: the user sends a user request for logging into the chat room to the server;

wherein the user may be a user in the normal state or a specified user in the restricted state; specifically, if the specified user wants to log into a chat room, the specified user will re-send the request for logging into the chat rooms to the sever, wherein the chat rooms include normal chat rooms and other specified chat rooms;

306: the server receives the user request for logging into the chat room, queries the status information of the user, and if the user is in the restricted state and the chat room which the user requests to log into is the specified chat room, accepts the request and turns to step 307; otherwise, rejects the request and turns to step 308;

furthermore, when the chat room administrator sends a request for canceling restrictions on the specified user, the server changes the status information of the user from the “restricted state” of the user into “normal state” according to the request. At this time, when the specified user sends the request for logging into a chat room, the login request of the specified user is permitted; or when the restriction time is up, the server changes the status information of the user from the “restricted state” of the user into “normal state”, for example: if the restriction time set by the chat room administrator is 1 min, when the time passes, the server will change the status information of the user from the “restricted state” of the user into “normal state”. At this time, when the specified user sends the request for logging into the chat room, the server permits the login request of the specified user. See the embodiment 2 for detailed steps;

furthermore, when the user is in the normal state, the server permits the user to log into any chat room, e.g. the normal chat room or other specified chat room;

307: the server permits the user to log into the specified chat room,

wherein after the server permits the user to log into the specified chat room, the client corresponding to the specified user will execute related login operations to make the specified user log into the specified chat room successfully, and then the flow ends.

308: the server rejects the user to log into the chat room;

wherein the specified user is continuously restricted in the specified chat room.

In a conclusion, this embodiment provides a method for restricting users from logging into the chat room. According to the method, the specified user sending adverse messages is forced to exit the current chat room and restricted in a certain specified chat room, and starts to count down the preset restriction time. When the specified user tries to log into other normal chat rooms in the restriction time, the server of the chat room rejects the login request, and the specified user cannot log into other normal chat rooms until the time is over or the client of the administrator sends the request to cancel the restriction; when the state is still being “restricted”, the specified user is permitted to log into other specified chat rooms. According to the above-mentioned method, the user forced to exit the current chat room is prevented from re-entering the chat room and affecting other users therein, but can still enjoy the chat room services in the chat room so as to avoid the chat room services losing users and improve the user experience.

### Embodiment 4

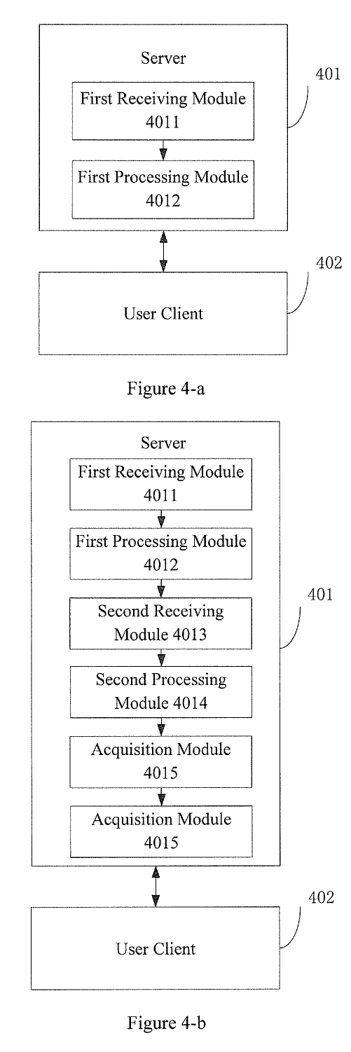

This embodiment provides a system for restricting a user from logging into a chat room. As shown in FIG. 4-a, said system comprises: a server 401 and a user client 402, wherein

the server 401 comprises a first receiving module 4011 and a first processing module 4012;

the first receiving module 4011 is used for receiving a request from the client corresponding to the chat room administrator for forcing a specified user to exit a current chat room;

the first processing module 4012 is used for sending the client of the specified user a command to force the specified user to exit the current chat room and changes the status information of the specified user into the restricted state to restrict the specified user in the specified chat room according to the request received by the first receiving module;

and the user client 402 is used for receiving the command from the server 401 so as to force the specified user to exit the current chat room.

Furthermore, as shown in FIG. 4-b, said server further comprises:

a second receiving module 403 for receiving a user request for logging into a chat room;

a second processing module 4014 for querying the status information of the user, when the user is in the restricted state and if the chat room which the user requests to log into is a specified chat room, accepting the request and permitting the user to log into the specified chat room; if the chat room which the user requests to log into is not the specified chat room, rejecting the request and refusing to log the user into the chat room;

wherein the user client 402 is also used for sending the user request for logging into the chat room to the server and permitting the user to log into the chat room after the server accepts the request.

Furthermore, the server further comprises:

an acquisition module 4015 for acquiring the restriction conditions of the specified user;

and a changing module 4016 for changing the status information of the specified user according to the restriction conditions acquired by the acquisition module.

The server and the user client in this embodiment and the server and the user client in the embodiment about method belong to the same concept, and the concrete realization processes refer to the embodiment about method.

In conclusion, this embodiment provides a system for restricting the users from logging into the chat room. According to the method, the specified user transmitting adverse messages is forced to exit the current chat room and restricted in the specified chat room in a period of time so as to prevent the user from re-entering the chat room and influencing other users therein, and ensuring that the user can still enjoy the chat room services, so the chat room services avoid losing users and the user experience gets better.

### Embodiment 5

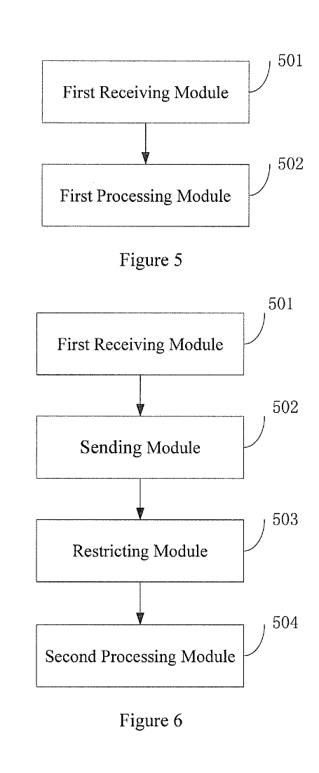

This embodiment provides a server for restricting users from logging into a chat room. As shown in FIG. 5, the server comprises:

a first receiving module 501 for receiving a request from the client corresponding to the chat room administrator for forcing a specified user to exit the current chat room;

a first processing module 502 for sending the client of the specified user a command to force the specified user to exit the current chat room and changing the status information of the specified user into the restricted state to restrict the specified user in the specified chat room according to the request received by the first receiving module 501.

Furthermore, as shown in FIG. 6, the server further comprises:

a second receiving module 503 for receiving a user request for logging into a chat room;

a second processing module 504 for querying the status information of the user, when the user is in the restricted state and if the chat room which the user requests to log into is a specified chat room, accepting the request and permitting the user to log into the specified chat room; if the chat room which the user requests to log into is not the specified chat room, rejecting the request and refusing to log the user into the chat room.

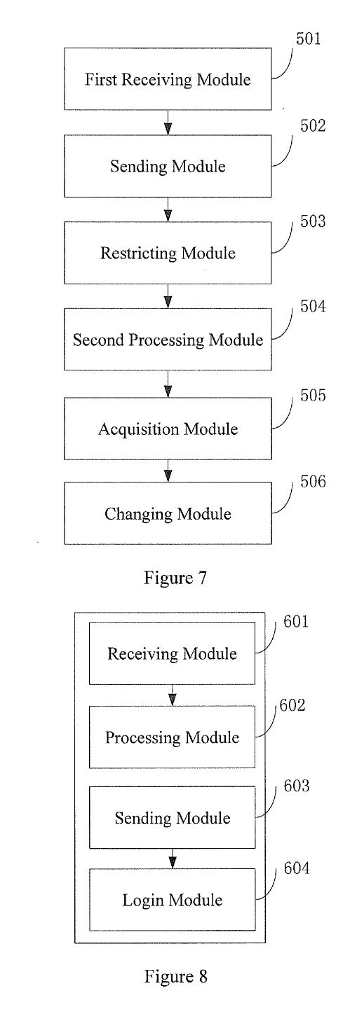

Furthermore, as shown in FIG. 7, the server further comprises:

an acquisition module 505 for acquiring the restriction conditions of the specified user;

and a changing module 506 for changing the status information of the specified user according to the restriction conditions acquired by the acquisition module.

In conclusion, this embodiment provides a system for restricting the users from logging into the chat room. According to the method, the server sends the specified user (sending adverse messages) a command to exit the current chat room and restricts the user in the specified chat room in a period of time so as to prevent the user re-entering the chat room and influencing other users therein and ensure that the user can still enjoy the chat room services, so the chat room services avoid losing users and the user experience gets better.

### Embodiment 6

This embodiment provides a user client for restricting users from logging into a chat room, as shown in FIG. 8. The user client comprises a receiving module 601 and a processing module 602 or a sending module 603 and a login module 604, wherein

the receiving module 601 is used for receiving a command from the server to force the specified user to exit the current chat room;

the processing module 602 is used for processing the command received by the receiving module 601 so as to make the specified user exit the current chat room;

the sending module 603 is used for sending the server a request for permitting the specified user to log into the chat room;

and the login module 604 is used for permitting the specified user to log into the chat room after the server receives the request.

In a conclusion, this embodiment provides a user client for restricting the users from logging into the chat room. According to the method, the user client receives the command from the server, makes the specified user transmitting adverse messages exit the current chat room, and restricts the user in the specified chat room in a period of time to keep the user from re-entering the chat room and influencing other users therein, and ensuring that the user can still enjoy the chat room services, so the chat room services avoid losing users and the user experience gets better.

In the embodiments, the word “acceptance” can be interpreted as acquiring or accepting messages from other modules.

The skilled persons in this field should understand that the attached drawings are only schematic views of a preferable embodiment and that the modules or flows in the drawings may not be the necessaries of the invention.

A skilled person in this field should understand that the modules in the devices of the embodiment may be arranged in the devices of the embodiment or arranged in one or more devices different from that in this embodiment via corresponding change. The modules in the abovementioned embodiment may be combined as a module or further dismantled into many sub-modules.

The series numbers of the embodiments of the invention are only intended for description and do not represent priority of the embodiments.

Some steps in the embodiments of the invention can be realized with software, and corresponding software can be stored in a readable memory medium, e.g. optical disc, hard disc, etc.

The above descriptions are only preferable embodiments of the present invention, which shall not restrict the present invention. Any amendment, equivalent replacement, improvement, etc. within the spirit and principle of the present invention shall be included in the protection scope of the present invention.

1. A method for restricting users from logging into a chat room, wherein said method comprises:
receiving a request from a client corresponding to a chat room administrator for forcing a specified user's identity to exit the current chat room;
and sending the client corresponding to the specified user a command to force the specified user's identity to exit the current chat room and changing the status information of the specified user into the restricted state to restrict the specified user's identity in a specified chat room according to the request.

2. The method according to claim 1, wherein said method further comprises:
receiving a user request for logging into a chat room;
querying the status information of the user;
and when the user is in the restricted state, if the chat room which the user requests to log into is a specified chat room, accepting the request and permitting the user to log into the specified chat room; if the chat room which the user requests to log into is not the specified chat room, rejecting the request and refusing the user to log into the chat room.

3. The method according to claim 1, wherein said method further comprises:
acquiring the restriction conditions of the specified user and changing the status information thereof according to the restriction conditions, wherein the restriction conditions are preset in a server or set by the chat room administrator and then sent to the server.

4. A system for restricting from logging into a chat room, wherein said system comprises a server and a user client, wherein the server comprises a first receiving module and a first processing module;
the first receiving module is used for receiving a request from a client corresponding to a chat room administrator for forcing a specified user's identity to exit the current chat room;
and the first processing module is used for sending the client corresponding to the specified user a command to force the specified user's identity to exit the current chat room and changing the status information of the specified user into the restricted state to restrict the specified user's identity in a specified chat room according to the request received by the first receiving module;
and the user client is used for receiving the command from the server to make the specified user's identity exit the current chat room.

5. The system according to claim 4, wherein said server further comprises:
a second receiving module for receiving a user request for logging into a chat room;
a second processing module for querying the status information of the user, when the user is in the restricted state and if the chat room which user requests to log into is a specified chat room, accepting the request and permitting the user to log into the specified chat room; if the chat room which the user requests to log into is not the specified chat room, rejecting the request and refusing the user to log into the chat room;
wherein the user client is also used for sending the user request for logging into the chat room to the server and permitting the user to log into the chat room after the server accepts the request.

6. The system according to claim 4, wherein said server further comprises:
an acquisition module for acquiring the restriction conditions of the specified user;
and a changing module for changing the status information of the specified user according to the restriction conditions acquired by the acquisition module.

7. A server, wherein said server comprises:
a first receiving module for receiving a request from a client corresponding to a chat room administrator for forcing a specified user's identity to exit the current chat room;
a first processing module for sending the client of the specified user a command to force the specified user's identity to exit the current chat room and changing the status information of the specified user into the restricted state so as to restrict the specified user's identity in the specified chat room according to the request received by the first receiving module.

8. The server according to claim 7, wherein said server further comprises:
a second receiving module for receiving a user request for logging into a chat room;
and a second processing module for querying the status information of the user and when the user is in the restricted state, if the chat room which the user requests to log into is a specified chat room, accepting the request and permitting the user to log into the specified chat room; if the chat room which the user requests to log into is not the specified chat room, rejecting the request and refusing the user to log into the chat room.

9. The server according to claim 7, wherein said server comprises:
an acquisition module for acquiring the restriction conditions of the specified user;
and a changing module for changing the status information of the specified user according to the restriction conditions acquired by the acquisition module.

10. A user client, wherein said user client comprises a receiving module and a processing module or a sending module and a login module, wherein
the receiving module is used for receiving a command from the server to force the specified user's identity to exit the current chat room;
the processing module is used for processing the command received by the receiving module so as to make the specified user's identity exit the current chat room;
the sending module is used for sending the server a request for permitting the specified user's identity to log into the chat room;
and the login module is used for permitting the specified user's identity to log into the chat room after the server receives the request.

11. A storage media comprising instructions of a method for restricting from logging into a chat room, wherein said method comprises:
receiving a request from a client corresponding to a chat room administrator for forcing a specified user's identity to exit the current chat room;
and sending the client corresponding to the specified user a command to force the specified user's identity to exit the current chat room and changing the status information of the specified user into the restricted state to restrict the specified user's identity in a specified chat room according to the request.

12. The storage media according to claim 11, wherein said method further comprises:
receiving a user request for logging into a chat room;
querying the status information of the user;
and when the user is in the restricted state, if the chat room which the user requests to log into is a specified chat room, accepting the request and permitting the user to log into the specified chat room; if the chat room which the user requests to log into is not the specified chat room, rejecting the request and refusing the user to log into the chat room.

13. The storage media according to claim 11, wherein said method further comprises:
acquiring the restriction conditions of the specified user and changing the status information thereof according to the restriction conditions, wherein the restriction conditions are preset in a server or set by the chat room administrator and then sent to the server.
